(19) United States
(12) Patent Application Publication
(10) Pub. No.: US 2012/0317238 A1
(43) Pub. Date: Dec. 13, 2012

(54) SECURE CROSS-DOMAIN COMMUNICATION

(75) Inventor: Evan Beard, San Francisco, CA (US)

(73) Assignee: SALESFORCE.COM, INC., San Francisco, CA (US)

(21) Appl. No.: 13/279,087

(22) Filed: Oct. 21, 2011

Related U.S. Application Data
(60) Provisional application No. 61/495,028, filed on Jun. 9, 2011.

(51) Int. Cl. G06F 15/16; G06F 3/048

(52) U.S. Cl. 709/219; 715/763

(57) ABSTRACT

Methods, systems, and devices are provided for obtaining information from third-party domains over a network in a secure manner. One exemplary approach involves loading, by a first domain on a first computing system, a second domain in an inline frame within the first domain and providing a script location on a third domain to the second domain. The second domain executes the script location on the third domain, for example, by generating a cross-domain function call such as a JSONP request, to obtain object data and provides the object data to the first domain. In one embodiment, a virtual application on the first domain presents at least a portion of the object data from the third domain within a web browser on a client device concurrently to presenting tenant data obtained from a multi-tenant database.

### CROSS-REFERENCE TO RELATED APPLICATION(S)

This application claims the benefit of U.S. provisional patent application Ser. No. 61/495,028, filed Jun. 9, 2011, the entire content of which is incorporated by reference herein.

### TECHNICAL FIELD

Embodiments of the subject matter described herein relate generally to computer systems and networks, and more particularly, embodiments of the subject matter relate to exchanging information across different domains in a secure manner.

### BACKGROUND

Web browsers are software applications that allow users to retrieve or otherwise access information via a communications network, such as the internet or another computer network. In some situations, web-based service providers may desire to aggregate information from various different locations on the network (e.g., from different domains, websites, servers, or the like). However, modern web browsers typically impose restrictions that limit the ability of web pages to access information on third-party domains (or websites) that are different from the domain (or website) that the web page is associated with, alternatively referred to as the same origin or single origin policy. To overcome the restrictions imposed by web browsers, various protocols, procedures, or techniques have been developed to exchange information across different domains. In this regard, it is desirable to provide adequate security protections and so that the requesting domain and/or web page is not vulnerable in the event the third-party domain being accessed becomes malicious or is otherwise compromised.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary computing device;

FIG. 2 is a block diagram of an exemplary communications system;

FIG. 3 is a flow diagram of an exemplary secure cross-domain scripting process;

FIG. 4 depicts an exemplary display that may be generated within a web browser on a client computing device in the communications system of FIG. 2 in connection with the secure cross-domain scripting process of FIG. 3 in accordance with one exemplary embodiment; and

FIG. 5 is a block diagram of an exemplary multi-tenant system suitable for generating the display of FIG. 4 within a virtual application accessed by a web browser on a client computing device in connection with the secure cross-domain scripting process of FIG. 3 in accordance with one exemplary embodiment.

### DETAILED DESCRIPTION

Embodiments of the subject matter described herein generally relate to obtaining data and/or information from a third-party domain in a secure manner such that the domain requesting the third-party data and/or information is not vulnerable in the event the third-party domain becomes malicious or is otherwise compromised. As described in greater detail below, in an exemplary embodiment, the initiating domain and/or web page requesting the third-party data loads a dummy domain (or dummy web page) within the initiating domain (e.g., within an inline frame) and provides the network address of the location of the desired data on the third-party domain (e.g., the uniform resource locator (URL), internet protocol (IP) address, or another network address associated with the desired data). The dummy domain obtains the requested data from the third-party domain by making a cross-domain function call, such as a JavaScript Object Notation (JSON) with padding (JSONP) request, and executing or otherwise evaluating a script with its source location corresponding to the network address of the location of the desired data on the third-party domain. The dummy domain provides the result of the script to the initiating domain, which parses and utilizes the script result in a desired manner. If the third-party domain becomes malicious or compromised, the dummy domain may be vulnerable but the initiating domain requesting the third-party data is effectively secure by virtue of the cross-domain restrictions in the web browser inhibiting or otherwise preventing a compromised dummy domain from undertaking any actions on the initiating domain.

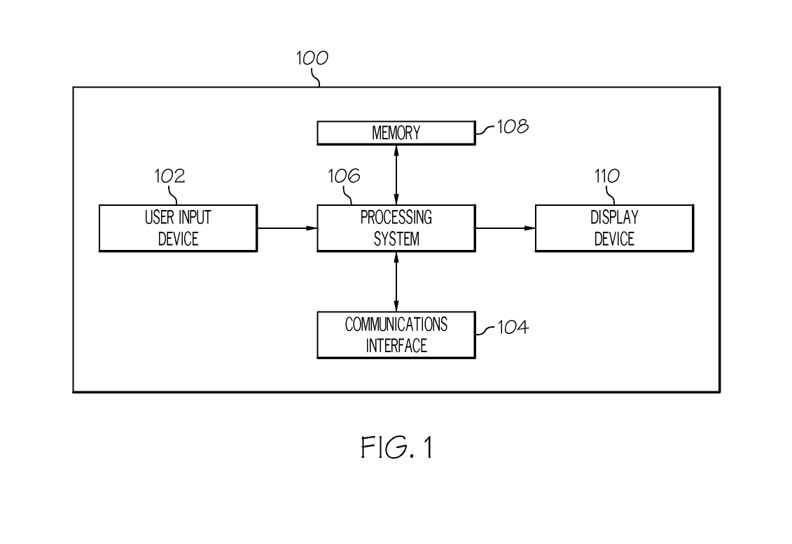

FIG. 1 depicts an exemplary embodiment of a computing device 100 suitable for performing or otherwise supporting the processes, tasks, functions, and/or operations described herein. The computing device 100 includes, without limitation, a user input device 102, a communications interface 104, a processing system 106, a memory 108, and a display device 110. Depending on the embodiment, the computing device 100 may be realized as a server, a computer, a mobile device, or another computing device. It should be understood that FIG. 1 is a simplified representation of the computing device 100 for purposes of explanation, and FIG. 1 is not intended to limit the subject manner described herein in any way.

In the illustrated embodiment, the user input device 102 generally represents the hardware and/or other components coupled to the processing system 106 and configured to provide a user interface with the computing device 100. For example, the user input device 102 may be realize as a key pad, a keyboard, a touch panel, a touchscreen, or any other device capable of receiving input from a user. The communications interface 104 generally represents the hardware, software, firmware and/or combination thereof that are coupled to the processing system 106 and configured to transmit and/or receive data packets to and/or from the computing device 100 via a communications network, such as the internet or another computer network. In this regard, the communications interface 104 may include one or more amplifiers, filters, modulators and/or demodulators, digital-to-analog converters (DACs), analog-to-digital converters (ADCs), antennas, or the like. In an exemplary embodiment, the display device 110 is realized as an electronic display device configured to graphically display information and/or content under control of the processing system 106.

In the computing device 100 of FIG. 1, the processing system 106 generally represents the hardware, software, firmware, processing logic, and/or other components of the processing system 106 configured to support operation of the computing device 100 and/or execute various functions and/or processing tasks described in greater detail below. Depending on the embodiment, the processing system 106 may be implemented or realized with a general purpose processor, a microprocessor, a controller, a microcontroller, a state machine, a content addressable memory, an application specific integrated circuit, a field programmable gate array, any suitable programmable logic device, discrete gate or transistor logic, discrete hardware components, or any combination thereof, configured to perform the functions described herein. Furthermore, the steps of a method or algorithm described in connection with the embodiments disclosed herein may be embodied directly in hardware, in firmware, in a software module executed by processing system 106, or in any practical combination thereof The memory 108 is coupled to the processing system 106, and the memory 108 may be realized as any non-transitory short or long term storage media capable of storing computer-executable programming instructions or other data for execution by the processing system 106, including any sort of random access memory (RAM), read only memory (ROM), flash memory, registers, hard disks, removable disks, magnetic or optical mass storage, and/or the like. In an exemplary embodiment, the computer-executable programming instructions, when read and executed by the processing system 106, cause the processing system 106 to execute and perform one or more of the processes tasks, operations, and/or functions described herein.

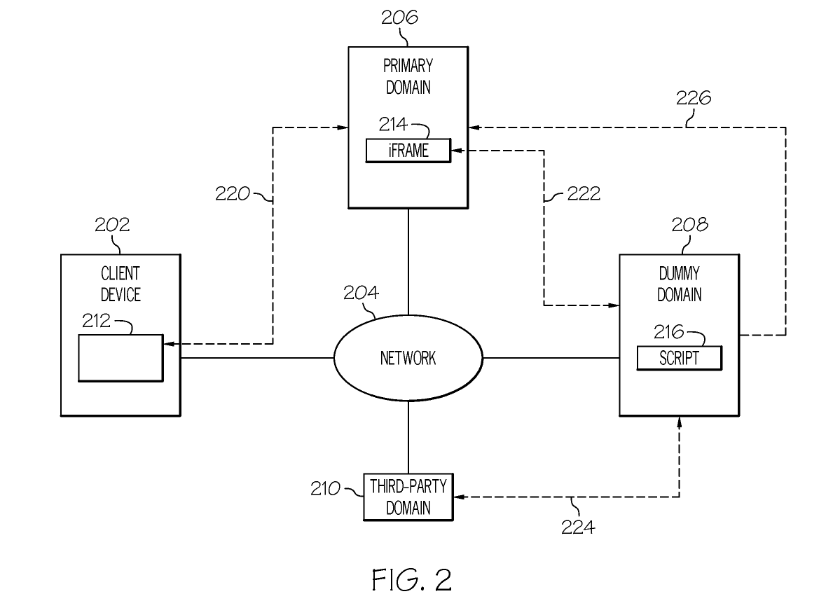

FIG. 2 depicts an exemplary embodiment of a communications system 200, which may include one or more instances of the computing device 100 of FIG. 1. The communications system 200 includes, without limitation, a client computing device 202, a communications network 204, a first domain 206 on the network 204, a second domain 208 on the network 204, and a third domain 210 on the network 204. Each of the domains 206, 208, 210 represents a website or other collection of web pages and/or resources having a unique domain name on the network 204 that is different from the domain names of the other domains 206, 208, 210. The web pages and/or resources corresponding to each respective domain 206, 208, 210 are stored on or otherwise maintained by a computing device (e.g., a web server or another computer) that is coupled to the network 204 and associated with the domain name of that respective domain 206, 208, 210. In this regard, in some embodiments, the web pages and/or resources for each of the domains 206, 208, 210 may be stored and/or maintained on separate computing devices, while in other embodiments, the web pages and/or resources for more than one of the domains 206, 208, 210 may be stored and/or maintained on a common computing device. For example, the web pages and/or resources for the first domain 206 and the web pages and/or resources for the second domain 208 may be stored on the same computing device while being logically separated or otherwise distinct from one another. It should be understood that FIG. 2 is a simplified representation of a communications system for purposes of explanation, and FIG. 2 is not intended to limit the subject manner in any way.

The communications network 204 may be realized as any wired and/or wireless computer network that supports communications between computing devices to allow one or more of the domains 206, 208, 210 on the network to be accessed by other computing devices coupled to the network 204, such as the client computing device 202. In exemplary embodiments, a user of the client computing device 202 operates or otherwise causes the client computing device 202 to execute a web browser 212 (or another application) to enable accessing or otherwise communicating with the first domain 206 over the network 204. In this regard, the web browser 212 is capable of retrieving, interpreting, displaying or otherwise presenting web pages, documents (e.g., hypertext markup language (HTML) documents, extensible markup language (XML) documents, or the like) and/or other resources that are maintained or otherwise located at the first domain 206 using a networking protocol, such as the hypertext transport protocol (HTTP), transmission control protocol and/or internet protocol (TCP/IP), or another Internet protocol.

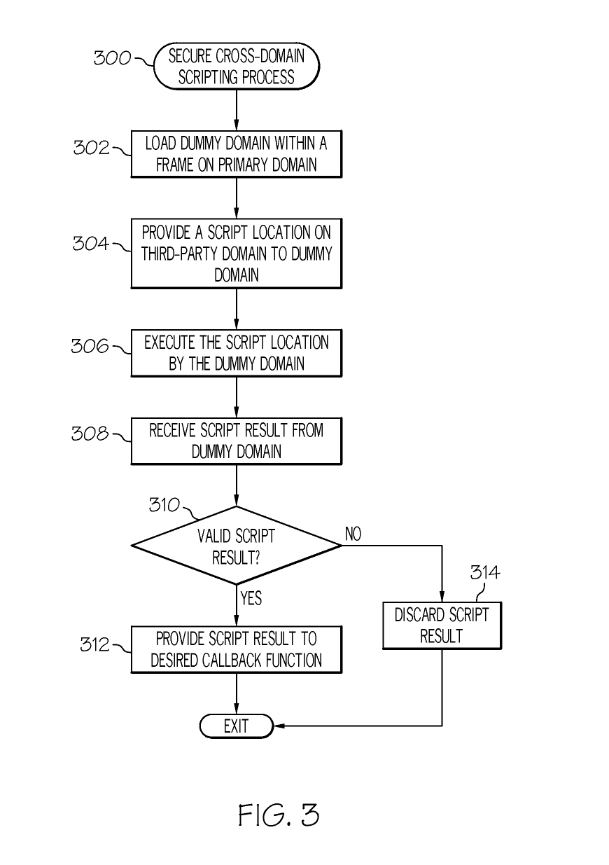

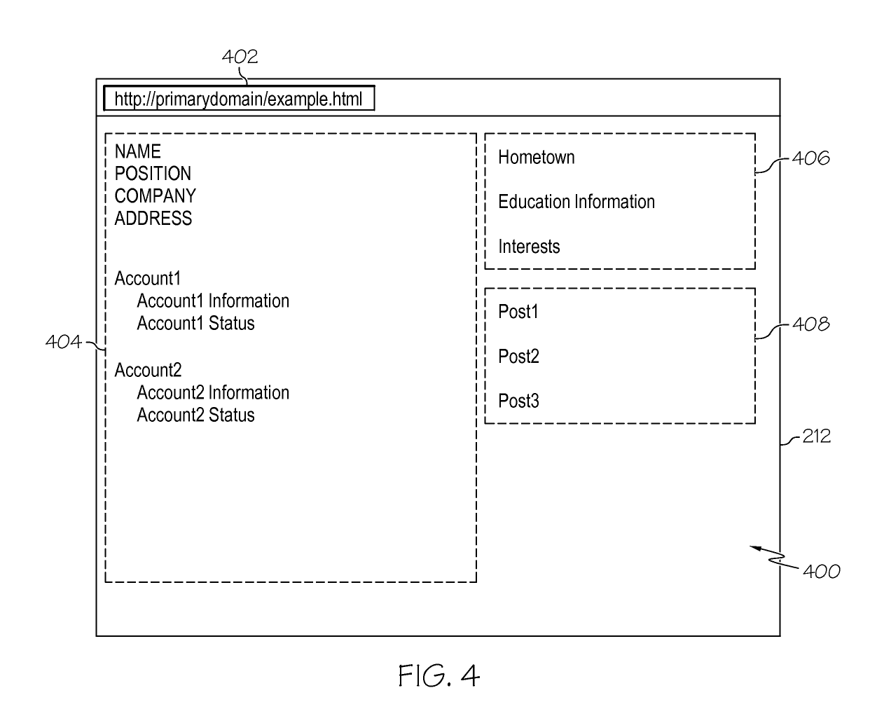

Still referring to FIG. 2, in an exemplary embodiment, the user of the client computing device 202 manipulates a user input device to direct the web browser 212 to a web page on the first domain 206 (e.g., by providing the URL or another network address associated with the first domain 206) and establish communications 220 with the first domain 206 over the network 204. For convenience, but without limitation, the first domain 206 may alternatively be referred to herein as the primary domain. The web browser 212 access and/or downloads the web page (or HTML document) available at the addressed location on the primary domain 206 and displays or otherwise presents the content of the web page on the client computing device 202. As described in greater detail below in the context of FIGS. 3-4, in an exemplary embodiment, the web page display presented within the web browser 212 on the client computing device 202 by the web page on the primary domain 206 includes data and/or information obtained from the third domain 210, alternatively referred to herein as the third-party domain, by performing a secure cross-domain scripting process. In this regard, the web page on the primary domain 206 communicates 222 with the second domain 208 (alternatively referred to herein as the dummy domain) over the network 204 and loads or otherwise accesses a web page maintained at an addressed location on the dummy domain 208 (e.g., a particular URL on the dummy domain 208) within the web page on the primary domain 206 using an inline (or internal) frame 214 (e.g., an HTML iframe). As described in greater detail below, the web page on the primary domain 206 provides a script location on the third-party domain 210 to the loaded web page from the dummy domain 208 within the frame 214, wherein the web page on the dummy domain 208 executes 224 the script location on the third-party domain 210 over the network 204 to obtain data and/or information from the third-party domain 210 and provides 226 the obtained data and/or information back to the web page on the primary domain 206. In an exemplary embodiment, the web page on the dummy domain 208 makes a JSONP request by loading an HTML script element having its src attribute equal to the script location on the third-party domain 210. The dummy domain 208 provides the script result (e.g., the JSON object data from the third-party domain 210) to the web page on the primary domain 206, wherein the web page on the primary domain 206 accesses or otherwise parses the script result and presents at least a portion of the third-party data and/or information within the displayed web page on the web browser 212 when the executed script returns valid JSON object data, as described in greater detail below.

FIG. 3 depicts an exemplary embodiment of a secure cross-domain scripting process 300 suitable for implementation by one or more computing devices in a communications system to obtain data and/or information from a third-party domain in a secure manner. The various tasks performed in connection with the illustrated process 300 may be performed by software, hardware, firmware, or any combination thereof For illustrative purposes, the following description may refer to elements mentioned above in connection with FIGS. 1-2. In practice, portions of the secure cross-domain scripting process 300 may be performed by different elements of the communications system 200, such as, the client computing device 202, the primary domain 206, the dummy domain 208, and/or the web browser 212. It should be appreciated that the process 300 may include any number of additional or alternative tasks, the tasks need not be performed in the illustrated order and/or the tasks may be performed concurrently, and/or the secure cross-domain scripting process 300 may be incorporated into a more comprehensive procedure or process having additional functionality not described in detail herein. Moreover, one or more of the tasks shown and described in the context of FIG. 3 could be omitted from a practical embodiment of the process 300 as long as the intended overall functionality remains intact.

Referring to FIG. 3, and with continued reference to FIGS. 1-2, in an exemplary embodiment, the process 300 begins after a user of the client computing device 202 manipulates a user input device (e.g., user input device 102) to direct the web browser 212 to a particular address or location on the primary domain 206 (e.g., by typing a URL or IP address on the primary domain 206 into the address bar of the web browser 212), wherein the web browser 212 downloads, retrieves, or otherwise accesses the web page (or HTML document) maintained at the addressed location on the primary domain 206. For purposes of explanation, the web page maintained at the addressed location on the primary domain 206 is alternatively referred to herein as the primary web page. For example, the user may provide the URL of the primary web page (e.g., http://primarydomain/example.html) in the address bar of the web browser 212 to establish communications 220 between the client computing device 202 and the computing system that hosts the primary domain 206 and allow the web browser 212 to retrieve the primary web page (e.g., the example.html document) from the primary domain 206 that is stored on its host computing system via the network 204.

In an exemplary embodiment, the process 300 begins with the primary domain loading or otherwise accessing the dummy domain within the primary domain (task 302). In this regard, in an exemplary embodiment, the primary web page on the primary domain 206 loads or otherwise accesses a web page (or HTML document) maintained at a particular address or location on the dummy domain 208 within the primary web page. For purposes of explanation, the web page (or HTML document) maintained at the addressed location on the dummy domain 208 that is loaded within the primary web page is alternatively referred to herein as the dummy web page. In an exemplary embodiment, the primary web page loads an inline frame 214 having a source location that corresponds to the addressed location of the dummy web page. For example, the primary web page may load a HTML iframe having its src attribute equal to the URL of the dummy web page (e.g., src=“http://dummydomain/dummydocument.html”) to load the dummy web page (e.g., dummydocument.html) within the primary web page. In an exemplary embodiment, the inline frame 214 within the primary web page made invisible to the user (e.g., by setting its dimensions to zero) so that the user of the client computing device 202 does not see the dummy web page within the web browser 212.

The process 300 continues by providing a script location on a third-party domain to the dummy web page on the dummy domain that is loaded within the primary web page on the primary domain (task 304). In this regard, the primary web page on the primary domain 206 transmits or otherwise provides a URL or IP address on the third-party domain 210 to the dummy web page loaded within the frame 214. For example, in accordance with one embodiment, if the web browser 212 is compatible with HTML5, the primary domain 206 may provide the URL corresponding to the script location on the third-party domain 210 (e.g., http://thirdpartydomain/script.html) using the postMessage command or another equivalent function to transmit the script location on the third-party domain 210 to the dummy web page on the dummy domain 208. In accordance with another embodiment, the primary domain 206 may provide the script location on the third-party domain 210 to the dummy web page on the dummy domain 208 as a hashtag parameter that is appended to the addressed location of the dummy web page when loading the inline frame. For example, the primary web page may concatenate the script location as a hashtag parameter following the URL of the dummy web page when setting the src attribute of the HTML iframe (e.g., src “http://dummydomain/dummydocument.html#thirdpartydomain/script.html”) to load the dummy web page (e.g., dummydocument.html) within the primary web page, with the dummy web page being configured to obtain the script location (thirdpartydomain/script.html) from the hashtag parameter in the src attribute of the iframe.

In an exemplary embodiment, the process 300 continues with the dummy domain generating a cross-domain function call to execute the script location on the third-party domain that was provided by the primary domain (task 306). In accordance with one embodiment, the dummy web page loaded within the iframe on the primary web page makes a JSONP request by loading, within the dummy web page on the dummy domain 208, a script having a source location corresponding to the location on the third-party domain provided by the primary web page. For example, the dummy web page may load an HTML script element having its src attribute equal to the script location on the third-party domain (e.g., src=“http://thirdpartydomain/script.html”) and evaluate or otherwise execute the script to obtain a result corresponding to the data and/or code provided by the web page maintained on the third-party domain 210 at the script location. It should be noted that the desired result of the script is JSON object data that is maintained or otherwise provided by the web page maintained at the script location on the third-party domain 210. In the event that the web page maintained at the script location on the third-party domain 210 has become compromised, any malicious code provided by the third-party domain 210 may be executed by the dummy web page on the dummy domain 208, which, in turn, may compromise the dummy domain 208, however, the cross-domain restrictions imposed by the web browser 212 inhibits or otherwise prevents the dummy web page and/or the dummy domain 208 from transmitting the malicious code back to the primary domain 206 or otherwise negatively impacting the primary web page and/or the primary domain 206.

In an exemplary embodiment, after the dummy web page and/or dummy domain executes the script location, the process 300 continues with the primary web page on the primary domain receiving the script result from the dummy web page on the dummy domain (task 308). In this regard, the dummy web page on the dummy domain 208 transmits or otherwise provides the third-party data and/or information obtained from the third-party domain 210 by executing and/or evaluating the script location back to the primary web page on the primary domain 206. Thus, the primary web page on the primary domain 206 receives data and/or information from the script location on the third-party domain 210 in a secure manner by using the dummy domain 208 as an intermediary, which protects the primary domain 206 from being impacted in the event the third-party domain 210 becomes malicious and/or compromised. In accordance with one embodiment, if the web browser 212 is compatible with HTML5, the dummy domain 208 provides the script result to the primary web page on the primary domain 206 using the postMessage command or another equivalent function to transmit the script result from the dummy web page on the dummy domain 208 directly to the primary web page on the primary domain 206. In another embodiment, the dummy web page provides the script result to the primary web page by setting the window name property of the inline frame 214 to the script result (e.g., window.name=“scriptresult”) and redirecting the inline frame 214 to a location on the primary domain 206. In this embodiment, the primary web page includes an onload event handler configured to obtain the window name of the inline frame 214, such that the script result is received from the window name property of the inline frame 214 response to the inline frame 214 being redirected to the primary domain 206.

In an exemplary embodiment, the process 300 continues by parsing the data and/or information received from the dummy domain to determine whether the script result is the expected type of object data and/or information (task 310). For example, the primary web page on the primary domain 206 may implement a JSON parser that receives and parses the script result provided by the dummy domain 208 and/or dummy web page to determine whether the script result is valid JSON object data. In response to determining the script result is valid object data, the process 300 continues by providing the script result to a desired callback function which accesses and utilizes the object data to produce a desired result (task 312). For example, as described in greater detail below in the context of FIG. 4, in accordance with one embodiment, the primary web page provides the third-party JSON object data received from the dummy web page to a callback function that arranges or otherwise formats the third-party JSON object data in a desired manner and generates a graphical representation of at least a portion of the third-party JSON object data that is displayed on the client computing device 202 (e.g., on its display device 110) within the web browser 212. Conversely, if the primary web page on the primary domain determines the script result is not valid object data of the desired type, the process 300 discards or otherwise ignores the script result and exits (task 314). After the process 300 is completed, the primary web page on the primary domain may destroy the inline frame used for loading the dummy domain or reuse the inline frame, for example, by repeating the process 300 to obtain data and/or information from additional third-party domains.

FIG. 4 depicts an exemplary embodiment of a display 400 that may be presented by a primary web page on a primary domain utilizing the process 300 of FIG. 3. In this regard, the display 400 may be presented by the primary web page within the web browser 212 on a client computing device 202 (e.g., on display device 110) in response to a user of the client computing device 202 directing the web browser 212 to the primary web page. For example, the user may manipulate the user input device 102 of the client computing device 202 to provide a URL in the address bar 402 of the web browser 212 corresponding to the primary web page on the primary domain 206, wherein the web browser 212 communicates 220 with the primary domain 206 to retrieve and present the primary web page. In an exemplary embodiment, the primary domain 206 supports a multi-tenant cloud-based application environment, wherein the primary web page provides a virtual customer relationship management (CRM) application that allows the user of the client computing device 202 to view and/or analyze contacts, customers, clients, sales, opportunities, activities, and the like. The user of the client computing device 202 may manipulate the user input device 102 to select a particular contact the user would like to view, wherein the CRM application on the primary web page obtains the data and/or information pertaining to the selected contact that is maintained by the primary domain 206 (e.g., in a multi-tenant database) and displays or otherwise presents the data maintained by the primary domain 206 in a first region 404 on the display 400 in the web browser 212.

Still referring to FIG. 4, in the illustrated embodiment, the primary domain 206 also maintains one or more URLs corresponding to web pages, documents and/or resources on one or more third-party domain(s) 210 that are associated with the selected contact. For example, the primary domain 206 may maintain a URL corresponding to the selected contact's user profile on a social networking website, a URL corresponding to the selected contact's personal website, a URL corresponding to the selected contact's blog, or the like. In this regard, in exemplary embodiments, the CRM application on the primary web page initiates the process 300 of FIG. 3 to obtain data and/or information pertaining to the selected contact from one or more third-party domain(s) 210 and present or otherwise display graphical representation of at least a portion of the obtained third-party data and/or information in additional regions 406, 408 on the display 400. For example, as described above, the CRM application on the primary web page may create an invisible HTML iframe having its src attribute equal to the URL of a dummy web page on the dummy domain 208 to load the dummy web page within the iframe. The CRM application provides the dummy web page with the URL corresponding to the selected contact's user profile on a third-party social networking website, wherein the dummy web page makes a JSONP request and executes a HTML script element having its src attribute equal to that URL for the selected contact's user profile. The dummy web page on the dummy domain 208 provides the JSON object data obtained from the social networking website to the CRM application, wherein the CRM application parses the JSON object data and provides the JSON object data to one or more callback functions to arrange and display at least a portion of the third-party data and/or information associated with the selected contact that was obtained from the social networking website in a second region 406 on the display 400. In a similar manner, the CRM application may repeat the steps of loading a dummy web page on the dummy domain 208 within an invisible iframe and providing the URL corresponding to the selected contact's blog to the dummy web page. As described above, the dummy web page makes a JSONP request to the contact's blog and provides the obtained JSON object data to the CRM application, wherein the CRM application parses the JSON object data and provides the JSON object data to one or more callback functions to display at least a portion of the data and/or information obtained from the selected contact's blog in a third region 408 on the display 400. In this manner, the virtual CRM application on the primary domain 206 may aggregate information pertaining to a selected contact from any number of different third-party domains in a secure manner without making the primary domain 206 vulnerable in the event one of the third-party domains is compromised and/or malicious.

It should be noted that FIG. 4 is a simplified representation of the display 400 for purposes of explanation and is not intended to limit the subject matter in any way. It will be appreciated that the subject matter described herein can be used for a variety of different web-based applications and with any number of third-party domains.

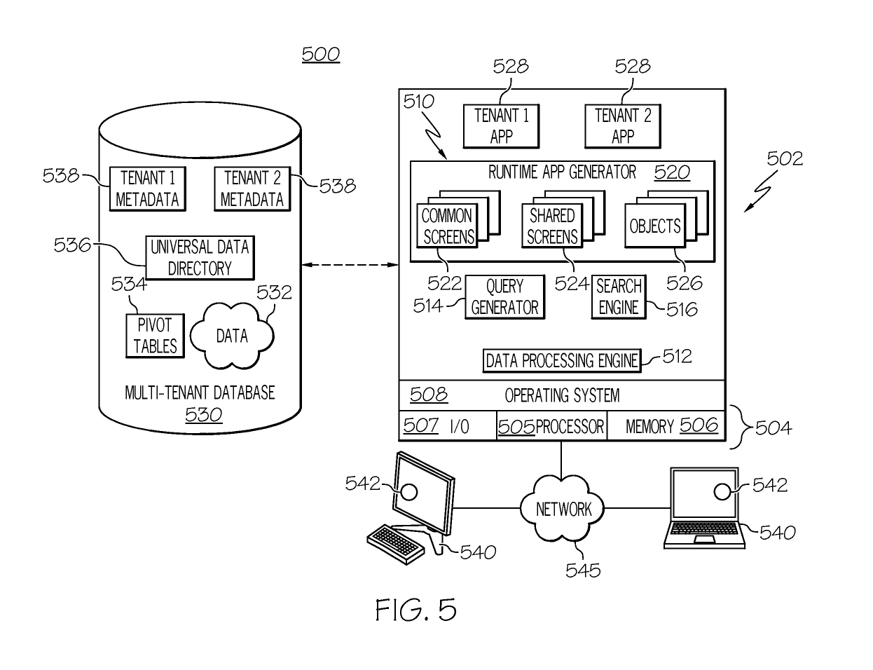

Turning now to FIG. 5, an exemplary multi-tenant system 500 suitably includes a server 502 that dynamically creates and supports virtual applications 528 based upon data 532 from a common database 530 that is shared between multiple tenants, alternatively referred to herein as a multi-tenant database. Data and services generated by the virtual applications 528 are provided via a network 545 to any number of client computing devices 540, as desired. Each virtual application 528 is suitably generated at run-time using a common application platform 510 that securely provides access to the data 532 in the database 530 for each of the various tenants subscribing to the multi-tenant system 500. In accordance with one non-limiting example, the multi-tenant system 500 is implemented in the form of a multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 530. In this regard, each tenant includes one or more users associated with, assigned to, or otherwise belonging to that respective tenant. Tenants may represent customers, customer departments, business or legal organizations, and/or any other entities that maintain data for particular sets of users within the multi- tenant system 500. Although multiple tenants may share access to the server 502 and the database 530, the particular data and services provided from the server 502 to each tenant can be securely isolated from those provided to other tenants. The multi-tenant architecture therefore allows different sets of users to share functionality without necessarily sharing any of the data 532 belonging to or otherwise associated with other tenants.

The multi-tenant database 530 is any sort of repository or other data storage system capable of storing and managing the data 532 associated with any number of tenants. The database 530 may be implemented using any type of conventional database server hardware. In some embodiments, the database 530 shares processing hardware 504 with the server 502, while in other embodiments, the database 530 is implemented using separate physical and/or virtual database server hardware that communicates with the server 502 to perform the various functions described herein.

In practice, the data 532 may be organized and formatted in any manner to support the application platform 510. In various embodiments, the data 532 is suitably organized into a relatively small number of large data tables to maintain a semi-amorphous “heap”-type format. The data 532 can then be organized as needed for a particular virtual application 528. In various embodiments, conventional data relationships are established using any number of pivot tables 534 that establish indexing, uniqueness, relationships between entities, and/or other aspects of conventional database organization as desired. Further data manipulation and report formatting is generally performed at run-time using a variety of metadata constructs. Metadata within a universal data directory (UDD) 536, for example, can be used to describe any number of forms, reports, workflows, user access privileges, business logic and other constructs that are common to multiple tenants. Tenant-specific formatting, functions and other constructs may be maintained as tenant-specific metadata 538 for each tenant, as desired. Rather than forcing the data 532 into an inflexible global structure that is common to all tenants and applications, the database 530 is organized to be relatively amorphous, with the pivot tables 534 and the metadata 538 providing additional structure on an as-needed basis. To that end, the application platform 510 suitably uses the pivot tables 534 and/or the metadata 538 to generate “virtual” components of the virtual applications 528 to logically obtain, process, and present the relatively amorphous data 532 from the database 530.

The server 502 is implemented using one or more actual and/or virtual computing systems that collectively provide the dynamic application platform 510 for generating the virtual applications 528. For example, the server 502 may be implemented using a cluster of actual and/or virtual servers operating in conjunction with each other, typically in association with conventional network communications, cluster management, load balancing and other features as appropriate. The server 502 operates with any sort of conventional processing hardware 504, such as a processor 505, memory 506, input/output features 507 and the like. The input/output features 507 generally represent the interface(s) to networks (e.g., to the network 545, or any other local area, wide area or other network), mass storage, display devices, data entry devices and/or the like. The processor 505 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 506 represents any non-transitory short or long term storage or other computer-readable media capable of storing programming instructions for execution on the processor 505, including any sort of random access memory (RAM), read only memory (ROM), flash memory, magnetic or optical mass storage, and/or the like. The computer-executable programming instructions, when read and executed by the server 502 and/or processor 505, cause the server 502 and/or processor 505 to establish, generate, or otherwise facilitate the application platform 510 and/or virtual applications 528 and perform additional tasks, operations, functions, and processes herein. It should be noted that the memory 506 represents one suitable implementation of such computer-readable media, and alternatively or additionally, the server 502 could receive and cooperate with computer-readable media (not separately shown) that is realized as a portable or mobile component or platform, e.g., a portable hard drive, a USB flash drive, an optical disc, or the like.

The application platform 510 is any sort of software application or other data processing engine that generates the virtual applications 528 that provide data and/or services to the client devices 540. In a typical embodiment, the application platform 510 gains access to processing resources, communications interfaces and other features of the processing hardware 504 using any sort of conventional or proprietary operating system 508. The virtual applications 528 are typically generated at run-time in response to input received from the client devices 540. For the illustrated embodiment, the application platform 510 includes a bulk data processing engine 512, a query generator 514, a search engine 516 that provides text indexing and other search functionality, and a runtime application generator 520. Each of these features may be implemented as a separate process or other module, and many equivalent embodiments could include different and/or additional features, components or other modules as desired.

The runtime application generator 520 dynamically builds and executes the virtual applications 528 in response to specific requests received from the client devices 540. The virtual applications 528 are typically constructed in accordance with the tenant-specific metadata 538, which describes the particular tables, reports, interfaces and/or other features of the particular application 528. In various embodiments, each virtual application 528 generates dynamic web content that can be served to a browser or other client program 542 associated with its client device 540, as appropriate.

The runtime application generator 520 suitably interacts with the query generator 514 to efficiently obtain multi-tenant data 532 from the database 530 as needed in response to input queries initiated or otherwise provided by users of the client devices 540. In a typical embodiment, the query generator 514 considers the identity of the user requesting a particular function (along with the user's associated tenant), and then builds and executes queries to the database 530 using system-wide metadata 536, tenant specific metadata 538, pivot tables 534, and/or any other available resources. The query generator 514 in this example therefore maintains security of the common database 530 by ensuring that queries are consistent with access privileges granted to the user that initiated the request.

Still referring to FIG. 5, the data processing engine 512 performs bulk processing operations on the data 532 such as uploads or downloads, updates, online transaction processing, and/or the like. In many embodiments, less urgent bulk processing of the data 532 can be scheduled to occur as processing resources become available, thereby giving priority to more urgent data processing by the query generator 514, the search engine 516, the virtual applications 528, etc.

In operation, developers use the application platform 510 to create data-driven virtual applications 528 for the tenants that they support. Such virtual applications 528 may make use of interface features such as tenant-specific screens 524, universal screens 522 or the like. Any number of tenant-specific and/or universal objects 526 may also be available for integration into tenant-developed virtual applications 528. The data 532 associated with each virtual application 528 is provided to the database 530, as appropriate, and stored until it is requested or is otherwise needed, along with the metadata 538 that describes the particular features (e.g., reports, tables, functions, etc.) of that particular tenant-specific virtual application 528. For example, a virtual application 528 may include a number of objects 526 accessible to a tenant, wherein for each object 526 accessible to the tenant, information pertaining to its object type along with values for various fields associated with that respective object type are maintained as metadata 538 in the database 530. In this regard, the object type defines the structure (e.g., the formatting, functions and other constructs) of each respective object 526 and the various fields associated therewith.

Still referring to FIG. 5, the data and services provided by the server 502 can be retrieved using any sort of personal computer, mobile telephone, tablet or other network-enabled client device 540 on the network 545. In an exemplary embodiment, the client device 540 includes a display device, such as a monitor, screen, or another conventional electronic display capable of graphically presenting data and/or information retrieved from the multi-tenant database 530, as described in greater detail below. Typically, the user operates a conventional browser or other client program 542 executed by the client device 540 to contact the server 502 via the network 545 using a networking protocol, such as the hypertext transport protocol (HTTP) or the like. The user typically authenticates his or her identity to the server 502 to obtain a session identifier (“SessionID”) that identifies the user in subsequent communications with the server 502. When the identified user requests access to a virtual application 528, the runtime application generator 520 suitably creates the application at run time based upon the metadata 538, as appropriate. As noted above, the virtual application 528 may contain Java, ActiveX, or other content that can be presented using conventional client software running on the client device 540; other embodiments may simply provide dynamic web or other content that can be presented and viewed by the user, as desired. As described in greater detail below, the query generator 514 suitably obtains the requested subsets of data 532 from the database 530 as needed to populate the tables, reports or other features of the particular virtual application 528.

Referring now to FIG. 5, and with reference to FIGS. 3-4, in an exemplary embodiment, a user of a client device 540 directs a web browser 542 executing on the client device 540 to access a first domain associated with the server 502, wherein the server 502 generates a virtual CRM application 528 within the web browser 542. Using the user identification and/or tenant identification information associated the user of the client device 540, the virtual application 528 obtains the subset of the tenant data 532 in the multi-tenant database that corresponds to the contacts, customers, clients, sales, opportunities, activities, and the like associated with the user's tenant that are viewable by the user. Within the virtual CRM application 528, the user of the client computing device 540 may manipulate a user input device to select a particular contact the user would like to view. In response, the virtual CRM application 528 generates a contact profile display (e.g., display 400) within the web browser 542 for presenting information associated with the selected content, wherein the virtual CRM application 528 obtains the profile information and/or data for that selected contact that is maintained as part of the user's tenant's data in the multi-tenant database 530 and displays or otherwise presents the at least a portion of the obtained profile information and/or data in a primary region (e.g., region 404) of the contact profile display (e.g., within a central frame inside the web browser 542). By virtue of the security features provided by the multi-tenant system 500, the multi-tenant database 530 may be understood as being part of or otherwise associated with the same domain as the server 502 and/or the virtual CRM application 528. In other words, the multi-tenant database 530 may be understood as being on the first (or primary) domain.

In an exemplary embodiment, the profile information for the selected contact obtained from the multi-tenant database 530 includes one or more web addresses, URLs, or other identifiers (e.g., a username, handle, or other identifier) for information and/or content associated with the selected contact on one or more third-party domains. The virtual CRM application 528 parses the profile information for the selected contact obtained from the multi-tenant database 530, identifies the web addresses, URLs, or other identifiers for information and/or content on one or more third-party domains, and performs the secure cross-domain scripting process 300 of FIG. 3 to obtain and display additional information associated with the selected contact from the web addresses, URLs, or other identifiers for information and/or content on one or more third-party domains to supplement the profile information and/or data from the multi-tenant database 530 with the third-party information and/or content. For example, the entry for the selected contact in the multi-tenant database 530 may include a URL corresponding to the selected contact's user profile on a third-party social networking website or another third-party website (e.g., the company website for the contact's employer's). The virtual CRM application 528 parses the data for the selected contact obtained from the multi-tenant database 530 to identify or otherwise obtain the address on the third-party domain that is associated with the selected contact (e.g., the URL corresponding to the selected contact's user profile on the social networking website), creates an invisible HTML iframe having its src attribute equal to the URL of a dummy web page on a dummy domain to load a dummy web page within the iframe, and provides the address on the third-party domain obtained from the multi-tenant database 530 to the dummy web page. As described above, the dummy web page makes a JSONP request by executing a HTML script element having its src attribute equal to the URL for the selected contact's user profile on the third-party social networking website and provides the JSON object data obtained from the social networking website to the virtual CRM application 528, which parses the JSON object data and displays at least a portion of the third-party information and/or data associated with the selected contact in a secondary region (e.g., region 406) of the profile display for the selected contact (e.g., in a smaller frame adjacent to or otherwise alongside the central frame including the profile information and/or data from the multi-tenant database 530). In this manner, the virtual CRM application 528 displays or otherwise presents profile information and/or data obtained from the multi-tenant database 530 for a selected contact and third-party information and/or data associated with the selected contact obtained from one or more third-party domains concurrently without exposing the server 502 to vulnerabilities in the event one of the third-party domains is compromised and/or malicious.

For the sake of brevity, conventional techniques related to computer programming, computer networking, cloud computing, web page design, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method of presenting information in a virtual application in a multi-tenant system, the virtual application being associated with a first domain, the method comprising:
loading, by the virtual application, a second domain within the virtual application;
providing, by the virtual application, a script location on a third domain to the second domain, wherein the second domain executes the script location on the third domain to obtain third-party data;
obtaining, by the virtual application, the third-party data from the second domain; and
presenting, by the virtual application, at least a portion of the third-party data within the virtual application.

2. The method of claim 1, further comprising:
obtaining, by the virtual application, second data from a multi-tenant database; and
presenting, by the virtual application, at least a portion of the second data within the virtual application concurrently to presenting the third-party data.

3. The method of claim 2, the virtual application comprises a customer relationship management application, wherein:
obtaining the second data comprises obtaining profile information for a selected contact from the multi-tenant database, the profile information including a third-party domain associated with the selected contact; and
providing the script location comprises providing the third-party domain to the second domain as the script location, wherein the second domain executes the third-party domain to obtain the third-party data.

4. The method of claim 1, further comprising:
generating, by a server coupled to a network, the virtual application within a web browser executing on a client device coupled to the network, the web browser accessing the first domain on the network, wherein:
the server is associated with the first domain on the network; and
presenting the portion of the third-party data within the virtual application comprises displaying the portion of the third-party data within the web browser on the client device.

5. The method of claim 4, the virtual application comprising a customer relationship management application, wherein the method further comprises:
obtaining, by the virtual application, profile information for a selected contact from a multi-tenant database coupled to the server;
generating, by the virtual application, a profile display for the selected contact within the web browser; and
displaying at least a portion of the profile information obtained from the multi-tenant database in a first region of the profile display, wherein:
the profile information includes a third-party domain associated with the selected contact;
providing the script location comprises providing the third-party domain to the second domain as the script location, wherein the second domain executes the third-party domain to obtain supplementary information associated with the selected contact from the third-party domain; and
displaying the portion of the third-party data within the web browser on the client device comprises displaying a portion of the supplementary information associated with the selected contact in a second region of the profile display.

6. The method of claim 1, wherein loading the second domain comprises loading an inline frame on the first domain having a source location corresponding to an addressed location on the second domain.

7. The method of claim 6, wherein the inline frame comprises a hypertext markup language (HTML) iframe element having its source (src) attribute equal to the addressed location.

8. The method of claim 6, wherein providing the script location comprises appending the script location to the addressed location as a hashtag parameter.

9. The method of claim 6, wherein providing the third-party data comprises:
setting a window name property of the inline frame to the third-party data; and
redirecting the inline frame to the first domain.

10. The method of claim 6, wherein executing the script location comprises generating a cross-domain call to the script location.

11. The method of claim 6, wherein executing the script location comprises making a JavaScript Object Notation with padding (JSONP) request to the script location.

12. The method of claim 11, wherein making the JSONP request comprises loading, by the second domain, a script corresponding to the script location.

13. The method of claim 12, wherein the script comprises a hypertext markup language (HTML) script element having its source (src) attribute equal to the script location.

14. A computing device comprising a processing system and a memory, wherein the memory comprises computer-executable instructions that, when executed by the processing system, cause the computing device to:
provide a first domain on a network coupled to the computing device;
generate a virtual customer relationship management application on the first domain;
load, within the virtual customer relationship management application, a second domain on the network;
provide a script location on a third domain to the second domain, wherein the second domain executes the script location on the third domain to obtain object data; and
receive the object data from the second domain.

15. The computing device of claim 14, the virtual customer relationship management application being generated within a web browser on a client computing device coupled to the network, the web browser accessing the first domain, wherein the computer-executable instructions cause the computing device to display a graphical representation of the object data within the virtual customer relationship management application in the web browser.

16. A method of obtaining information over a network from a third-party domain for presentation by a virtual application generated by a server in a multi-tenant system, the virtual application being provided to a client device coupled to the network, the client device executing a web browser accessing a first domain on the network associated with the server, the method comprising:
loading, by the virtual application, a dummy web page on a dummy domain coupled to the network within a frame;
providing, by the virtual application, a script location on the third-party domain to the dummy web page, wherein the dummy web page executes the script location to obtain third-party data;
receiving, by the virtual application, the third-party data from the dummy web page; and
generating, by the virtual application, a display within the web browser, wherein the display includes a graphical representation of at least a portion of the third-party data.

17. The method of claim 16, further comprising obtaining, by the virtual application, tenant data from a multi-tenant database coupled to the server, wherein the display includes a graphical representation of at least a portion of the tenant data.

18. The method of claim 17, the tenant data including an address on the third- party domain, wherein providing the script location comprises providing the address from the tenant data to the dummy web page, the dummy web page executing the address to obtain the third-party data.

19. The method of claim 16, wherein the virtual application comprises a customer relationship management application configured to generate the display by:
displaying the portion of the tenant data in a primary region within the web browser; and
displaying the portion of the third-party data in a secondary region within the web browser.

20. The method of claim 16, wherein:
the frame comprises a hypertext markup language (HTML) iframe element having its source (src) attribute equal to a uniform resource locator (URL) associated with the dummy web page;
the script location comprises a second URL on the third-party domain; and
the dummy web page executes the script location by evaluating a HTML script element having its src attribute equal to the second URL.
